(19) United States
(12) Patent Application Publication
(10) Pub. No.: US 2016/0298673 A1
(43) Pub. Date: Oct. 13, 2016

(54) TAPPED INSERT

(71) Applicant: CLUFIX, Cluses (FR)

(72) Inventor: Alex Grojean, Commercy (FR)

(21) Appl. No.: 15/092,686

(22) Filed: Apr. 7, 2016

(30) Foreign Application Priority Data
Apr. 10, 2015 (FR) 15 53166

(51) Int. Cl. F16B 37/00

(52) U.S. Cl. CPC F16B 37/00

(57) ABSTRACT

A metal insert (1) in a single piece comprising:
a body (2) which extends according to a longitudinal axis (I-I) between a first end (3) which, is open with an inlet orifice (4) and a second end (5),
between the first (3) and second (5) ends, a longitudinal passage (6) comprising a section (7) which is threaded in its interior,
an end wall (8) which closes the second end (5). The end wall (8) is made of metal which is worked radially in the direction of the longitudinal axis (I-I).

### TECHNICAL FIELD OF THE INVENTION

The present invention relates to the field of fastening, and relates more particularly to a metal insert in a single piece which is tapped in its interior in order to receive a fastening screw, and is designed to be overmolded in a part made of injected material, for example plastic material.

In order to fasten a part made of plastic material, it is known to use a metal insert in a single piece which is tapped in its interior and overmolded in the plastic part during the injection of the latter. The metal insert in a single piece has mechanical characteristics in order to ensure the retention of the screw which are very much better than those of the plastic material which constitutes the part.

When sealing must be ensured between two opposite faces of an injected part which receives a metal insert in a single piece which is tapped in its interior, a metal insert in a single piece is conventionally used as illustrated in FIG. 1. A metal insert in a single piece of this type comprises:
a body C which extends according to a longitudinal axis L-L, between a first open end E1 with an inlet orifice OE and a second end E2,
between the first and second ends E1 and E2, a longitudinal passage PL comprising a section TFI which is threaded in its interior,
an end wall PF which closes the second end E2.

An insert of this type is put into place in ah injection mold before injection of the material which is designed to constitute the part (such as plastic). During this putting into place, the first end. E1 is placed against a wall of the mold or is fitted on a lug which is supported in the indentation of the mold in order to block the inlet orifice OE and prevent the injected material from penetrating into the section TFI which is threaded in its interior, which would put the metal insert in a single piece out of use (as well as the part in which it is overmolded). Since the second end E2 is closed by the end wall PF, the injected material cannot penetrate into the longitudinal passage PL via the second end E2.

During the production of the insert, the thread of the section TFI which is threaded in its interior is produced by tapping by means of a tap introduced into the longitudinal passage through the inlet orifice OE. In order to tap the section TFI which is threaded in its interior along its entire predetermined length, it is necessary to provide a clearance section TD for the end of the tap. The clearance section TD prevents the end of the tap from being supported against the end wall PF. In fact, in the case of a support of this type, either the end wall PF would be broken, and would no longer close the second end sufficiently, or the tap would break.

The clearance section TD has a length which is proportional to the dimensions of the tapping: In practice it increases the total length of the metal insert in a single piece to be overmolded by approximately 40% to approximately 80% of the section TFI which is threaded in its interior. This makes it impossible to produce injected parts with a narrow thickness, without providing bosses which will contain the overmolded metal inserts in a single piece.

In addition, the clearance section TD is smooth in its interior, and has an inner diameter DI which is smaller than the diameter DFF at the end of the thread of the section TFI which is threaded in its interior. Thus, when a screw penetrates into the insert according to a screwing course which is too long, the end of the threaded shank of the screw can get stuck in the clearance section TD, which can give rise to separation in rotation of the insert from the part made of plastic material, and/or prevent the removal of the screw from the insert by unscrewing.

In order to reduce the total length of the insert, a solution has consisted of producing a metal insert in a single piece with a through longitudinal passage, i.e. which opens out at both ends of the body. The metal insert in a single piece can then be without a clearance section. A stopper is then added onto the second end during an adjustment operation, in order to close it, as described in document FR 2 788 316 A1. Although the length of a metal insert in a single piece of this type can be shorter than that of the insert in FIG. 1, its production is more costly, since it requires separate production of a plurality of parts, and a subsequent assembly operation. Moreover, the problems in the event of an excessive screwing course are not eliminated.

### SUMMARY OF THE INVENTION

A problem which is posed by the present invention consists of designing a metal insert in a single piece which is threaded in its interior, provided at one of its ends with a closing end wall, which insert has a reduced length between the section which is threaded in its interior and the end wall, and which can he produced simply and more cheaply.

In order to achieve these objectives as well as others, the invention proposes a metal insert, in a single piece comprising:
a body which extends according to a longitudinal axis between a first end which is open with an inlet orifice and a second end,
between the first and second ends, a longitudinal passage comprising a section which is threaded in its interior,
an end wall which closes the second end,
   according to the invention, the end wall is made of metal which is worked radially in the direction of the longitudinal axis.

Before the metal has been worked radially, the longitudinal passage of the insert opens out at the second end, thus permitting the passage or overshooting of a tap during the tapping operations. It is therefore not necessary to provide a clearance section, such that the final length of the insert can be reduced.

After the tapping operations have been carried out, the second end is closed by working of the material which constitutes the tubular peripheral wall of the insert, in order to form an end wall which closes the second end. This closure of the second end does not require addition of a part which is manufactured separately. It is also possible to work material ending in an end wall which is ultimately at a reduced distance from the section which is threaded in its interior, in order at the end of production to obtain an insert, the total length of which is reduced. It is therefore possible, between the section which is threaded in its interior and the second end, to obtain a length of the threaded section which is shorter by 40% to 80%.

According to the present invention, “closing” the second end by means of the end wall means obstruction of the second end which is sufficient to prevent the penetration of injected material to an extent which puts the insert out of use. The obstruction can be total by means of a continuous end wall. However, the obstruction can be only partial, with a small hole being able to subsist substantially in the center of the end wall after its production by working of metal. But in the case of obstruction which is only partial, the hole has n dimensions which are small enough to prevent the injected material from penetrating sufficiently to make the insert unusable. These dimensions can vary according to the characteristics of the material injected (viscosity in particular) and the injection carried out (injection pressure in particular). The end wall according to the invention can thus block the second end of the insert completely, and form a continuous end wall, or it can block the second end of the insert substantially, because of the subsistence of a small hole.

Advantageously, the section which is threaded in its interior can extend from the inlet orifice, and in the direction of the second end. This therefore prevents unnecessary extension of the insert between the section which is threaded in its interior and the first end.

Preferably, between the section which is threaded in its interior and the end wall, the longitudinal passage can comprise a section, which is smooth in its interior, with an inner diameter which is larger than the diameter at the end of the thread of the section which is threaded in its interior.

A section of this type which is smooth in its interior constitutes a clearance section for the end of a screw which penetrates into the insert according to an excessive course. When the threaded end of the screw penetrates into the section which is smooth in its interior, no sticking (blocking in rotation) of the screw takes place in the insert, because the section which is smooth in its interior has an inner diameter which is distinctly larger than the diameter of the screw at the top of the thread. The clearance section constituted by the section which is smooth in its interior can have a shorter length than that of the clearance section TD of the insert according to the prior art illustrated in FIG. 1.

Advantageously, the insert can comprise a flange on the outer surface of the body. This flange makes it possible to oppose efficiently an axial force (according to the longitudinal axis) of extraction of the insert from the plastic part after overmolding.

Preferably, the insert can comprise, means for blocking its rotation around the longitudinal axis after overmolding. This therefore limits the risks of the insert being able to rotate relative to the plastic part, which would give rise to the engagement of a screw by screwing into the insert. For this purpose, in practice it is possible to provide the insert with a section which has a non-circular transverse cross section on the outer surface of the body.

According to another aspect of the invention, a method is proposed for production of a metal insert in a single piece with a total length which can be reduced, said method making it possible to close the insert at one of its ends economically.

In order to achieve these objectives as well as others, the invention proposes a production method comprising the following steps:

1) providing a metal insert in a single piece comprising:
a body which extends according to a longitudinal axis between a first end which is open with an inlet orifice and a second end,
between the first and second ends, a longitudinal passage comprising a section which is threaded in its interior,
a hollow open end section, comprising a cylindrical wall, said end section extending the section which is threaded in its interior away from the first open end,

2) working at least part of the cylindrical wall of the end section by deformation, by turning it down radially in the direction of the longitudinal axis until the second end of the body is closed.

The metal insert in a single piece in step 1 can be provided by means of production on a single machining station, such that its production at a low cost can be envisaged.

The operation of closure of the insert at its second end does not require the addition of a part previously manufactured separately. Also, it is possible to carry out working of material ending at an end wall which is ultimately at a reduced distance from the section which is threaded in its interior, in order to obtain an insert with a reduced total length at the end of production. An excessive length between the section which is threaded in its interior and the second end can be avoided.

Advantageously, the end section can be smooth in its interior, and comprise an inner diameter which is larger than the diameter at the end of the thread of the section which is threaded in its interior. It is thus possible to provide the insert with a section which is smooth in its interior, which separates the section which is threaded in its interior from the end wall, said section which is smooth in its interior constituting a clearance section for the end of a screw which penetrates according to an excessive course into the section of the insert which is threaded in its interior. However, this clearance section does not increase the total length of the insert as much as the clearance section TD in the insert according to the prior art illustrated in FIG. 1.

Advantageously, step 2) can be carried out by means of flow turning.

As an alternative, step 2) can be carried out by longitudinal axial pressing of the end section of the metal insert in a single piece against, an anvil. A plurality of anvils with different forms can be used in succession in order to turn the cylindrical wall of the end section down progressively radially in the direction of the longitudinal axis.

According to another aspect of the invention, a production method comprising the following steps is proposed:

A) providing a metal rod which extends according to a longitudinal axis,

B) at a free end of the metal rod, piercing a first blind longitudinal hole comprising a first diameter,

C) tapping the first longitudinal hole along at least part of its length by introducing a tap into the first longitudinal hole from the free end of the metal rod,

D) working by deformation at least part of the material which constitutes the free end of the metal rod by turning it down radially in the direction of the longitudinal axis until the first longitudinal hole is closed,

E) truncating the metal rod radially corresponding to an area which is at least partly tapped of the first longitudinal hole.

A production method of this type permits production of a metal insert in a single piece as previously described, and can be carried out on a single machining station, without an adjustment operation.

Preferably, it can be provided that:
before the step C), at the free end of the metal rod, a second longitudinal hole is pierced comprising second diameter,
the second diameter is larger than the diameter at the end of the tapping thread which is produced during the step C),
during the step D), there is no deformation of the material which constitutes the free end of the metal rod on a portion of the second longitudinal hole, said portion being adjacent to the tapping carried out during the step C).

It is thus possible to provide the insert with a section which is smooth in its interior, which separates the section which is threaded in its interior from the end wall, said section which is smooth in its interior constituting a clearance section for the end of a screw which penetrates into the section of the insert which is threaded in its interior according to an excessive course.

Advantageously, before the step D), a lateral surface of the metal rod can be machined in order to produce a section with a non-circular transverse cross section and/or a flange. The flange opposes any force which tends to extract the insert from the injected part, whereas the section with a non-circular transverse cross section opposes rotation of the insert relative to the injected part.

Advantageously, the step D) can be carried out by flow turning.

As an alternative, the step D) can be carried out by longitudinal axial pressing of the free end of the metal rod against an anvil. A plurality of anvils with different forms can be used in succession in order to turn the cylindrical wall of the end section down progressively radially in the direction of the longitudinal axis.

### BRIEF DESCRIPTION OF THE DRAWINGS

Other objectives, characteristics and advantages of the present invention will become apparent from the following description of particular embodiments, provided in relation to appended figures, in which:

FIG. 1 is a view in longitudinal cross section of a metal insert in a single piece which forms part of the prior art;

FIG. 2 is a view in longitudinal cross section of a first embodiment of a metal insert in a single piece according to the invention;

FIG. 3 is a view in longitudinal cross section of a second embodiment of a metal insert in a single piece according to the invention;

FIGS. 4 and 5 are views in longitudinal cross section illustrating a first method of production of the metal insert in a single piece in FIG. 2 or 3;

FIG. 6 is a view in partial longitudinal cross section illustrating a variant of the first method for production of the metal insert in a single piece in FIG. 2 or 3; and

FIGS. 7 to 14 are views in longitudinal cross section illustrating a second method, for production of the metal insert in a single piece in FIG. 2 or 3.

### DESCRIPTION OF THE PREFERRED EMBODIMENTS

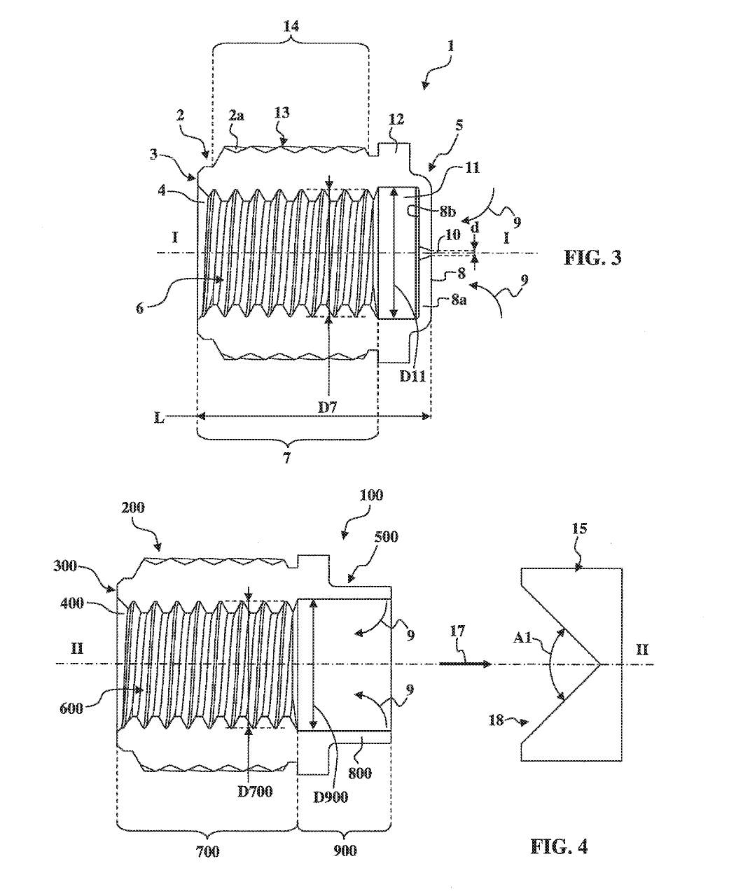

FIGS. 2 and 3 illustrate in longitudinal cross section two embodiments of a metal insert 1 in a single piece according to the invention.

Each metal insert 1 in a single piece comprises a body 2 which extends according to a longitudinal axis I-I between a first open end 3 with an inlet orifice 4, and a second end 5. A longitudinal passage 6 extends between the first and second ends 3 and 5, and comprises a section 7 which is threaded in its interior. An end wall 8 closes the second end 5. The end wall 8 is made of metal which is worked radially in the direction of the longitudinal axis according to a movement illustrated by the arrows 9.

In the embodiment illustrated in FIG. 2, the outer face 8a of the end wall is continuous, such that the end wall 8 closes completely the second end 5 of the insert 1.

In comparison, in the embodiment illustrated in FIG. 3, the end wall 8 closes the second end 5 of the insert 1 almost entirely, the outer face of the end wall 8 being discontinuous because of the subsistence of a small hole 10 in its center after working of the metal in order to produce the end wall 8. The small hole 10 puts the longitudinal passage 6 into communication with the exterior through the end wall 8. However, in order for the insert 1 in FIG. 3 to be able to be used to be overmolded in an injected part, the hole 10 has a diameter d in the vicinity of the outer face 8a which is small enough to prevent a quantity of injected material which could make the section 7 which is threaded in its interior unusable from penetrating into the longitudinal passage 6. In practice, a diameter d of 1 mm or less is generally found to be satisfactory.

In order to reduce as far as possible the total length L of the insert 1, the section 7 which is threaded in its interior extends directly from the inlet orifice 4 in the direction of the second end. 5. As an alternative, the section 7 which is threaded in its interior can be preceded by a very short frusto-conical section which extends from the inlet orifice 4, said frusto-conical section being designed to facilitate the introduction of a screw into the insert 1. In all cases, it is necessary to avoid the presence between the inlet orifice 4 and the section 7 which is threaded in its interior of a cylindrical section which is smooth in its interior, which would extend the total length L of the insert 1 unnecessarily.

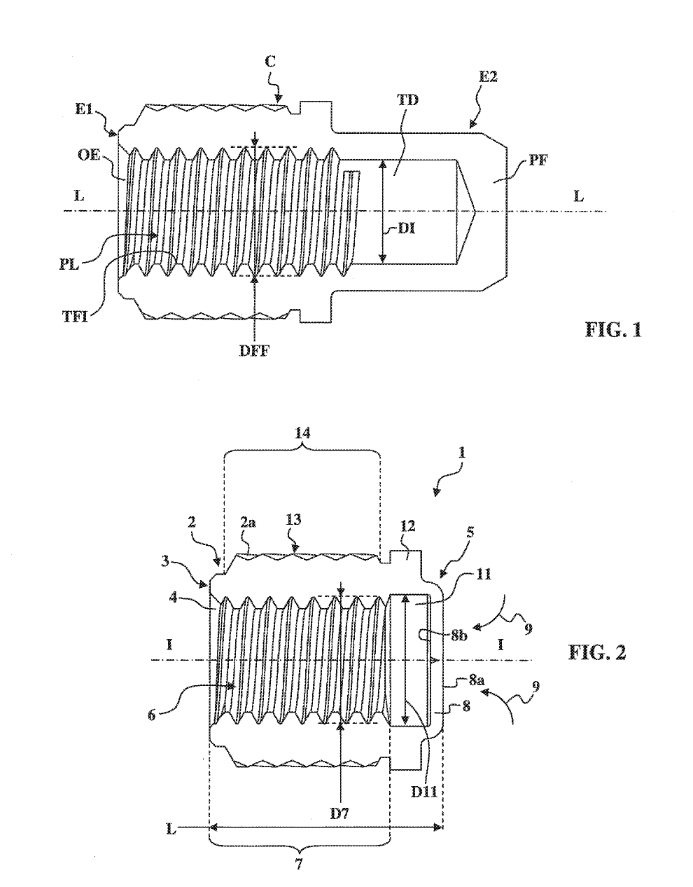

in FIGS. 2 and 3, between the section 7 which is threaded in its interior and the end wall 8, the longitudinal passage comprises a section 11 which is smooth in its interior with an inner diameter D11 larger than the diameter D7 at the end of the thread of the section, which is threaded in its interior. The section 11 which is smooth in its interior constitutes a clearance section for the threaded end of a screw in the case of an excessive screwing course. The section 11 which is smooth in its interior increases the total length L of the insert 1 less than the clearance section TD of the insert according to the prior art illustrated in FIG. 1

On the outer surface 2a of the body 2, the insert 1 additionally comprises a flange 12 which is designed to oppose an attempt at axial extraction of the insert 1 from the part after injection.

The insert 1 also comprises means 13 for blocking its rotation around the longitudinal axis after overmolding, relative to the injected part. In this case, in practice, the insert 1 comprises a section 14 with a non-circular transverse cross section on the outer surface 2a of the body 2. The section. 14 is obtained by knurling.

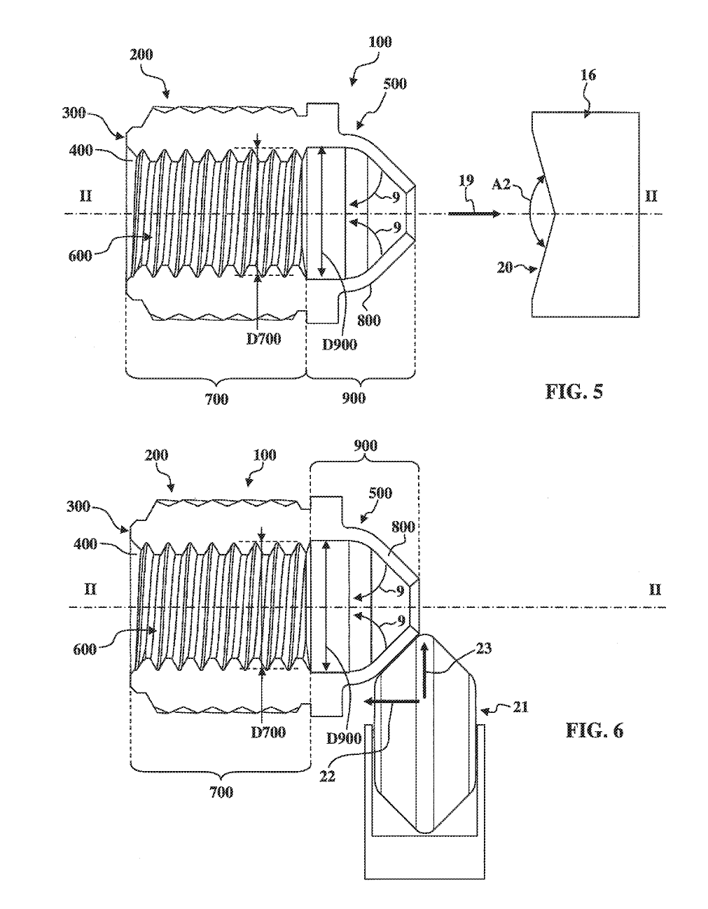

FIGS. 4 and 5 illustrate a first method for production of a metal insert 1 in a single piece as illustrated in FIGS. 2 and 3.

This production method comprises a step 1) consisting of supplying a metal insert 100 in a single piece comprising:
a body 200 which extends according to a longitudinal axis II-II between a first open end 300 with an inlet orifice 400 and a second end 500,
between the first and second ends 300 and 500, a longitudinal passage 600 comprising a section 700 which is threaded in its interior,
a hollow open end section 900 comprising a cylindrical wall 800, said end section 900 extending the section 700 which is threaded in its interior away from the first open end 300.

The method comprises a step 2) consisting of working by deformation at least part of the cylindrical wall 800 of the end section 900 by turning it down radially in the direction of the longitudinal axis II-II (according to a movement illustrated by the arrows 9) until the second end 500 of the body 200 is closed.

In FIGS. 4 and 5, it can be seen that the end section 900 is smooth in its interior, and comprises an inner diameter D900 which is larger than the diameter D700 at the end of the thread of the section 700 which is threaded in its interior. Thus, after working only part, of the cylindrical wall 800 of the end section 900, an insert 1 as illustrated in FIG. 2 or 3 is obtained with a section 11 which is smooth in its interior separating the section 7 which is threaded in its interior from the end wall 8.

According to a first possibility, the working of the cylindrical wall 800 of the end section 900 can be carried out by longitudinal axial pressing of the end section 900 against anvils 15 and 16, as illustrated in FIGS. 4 and 5.

In this case, the insert 100 is firstly pressed axially according to the longitudinal direction II-II against the anvil 15, according to the movement illustrated by the arrow 17 (FIG. 4). The anvil 15 has a conical indentation 18 with an angle A1. After this axial pressing, the insert 100 is in the configuration as illustrated, in FIG. 5, in which part of the cylindrical wall 800 of the end section 900 has been turned down radially in the direction of the longitudinal axis II-II. The insert 100 is then pressed axially against the anvil 16 according to the longitudinal axis II-II by a movement illustrated by the arrow 19. The anvil 16 comprises a conical indentation 20 with an angle A2 which is greater than the angle A1 of the anvil 15, so as to work the cylindrical wall 800 of the end section 900 even more in the direction of the longitudinal axis II-II.

After the axial pressing against the anvil 16, the insert 100 can be pressed against a final anvil with a flat face, which makes it possible to bring the cylindrical wall 800 of the end section 900 into the configuration illustrated in FIG. 2 or 3, i.e. by turning down at least part of the cylindrical wall 800 perpendicular to the longitudinal axis II-II until the second end 500 of the body 2 is closed substantially, or even completely.

In a variant of the first production method, the step 2) is carried out by flow turning as illustrated in FIG. 6. In this FIG. 6, part of the cylindrical wall 800 of the end section 900 is turned down in the direction of the longitudinal axis II-II by a flow turning knurling wheel 21 which is displaced axially according to the movement illustrated by the arrow 22, and radially according to the movement illustrated by the arrow 23, until it reaches the configuration illustrated in FIG. 2 or 3, in which part of the cylindrical section 900 of the end section 900 is perpendicular to the longitudinal axis II-II and closes the second end 500 of the body 200 substantially, or even completely, thus forming the end wall 8.

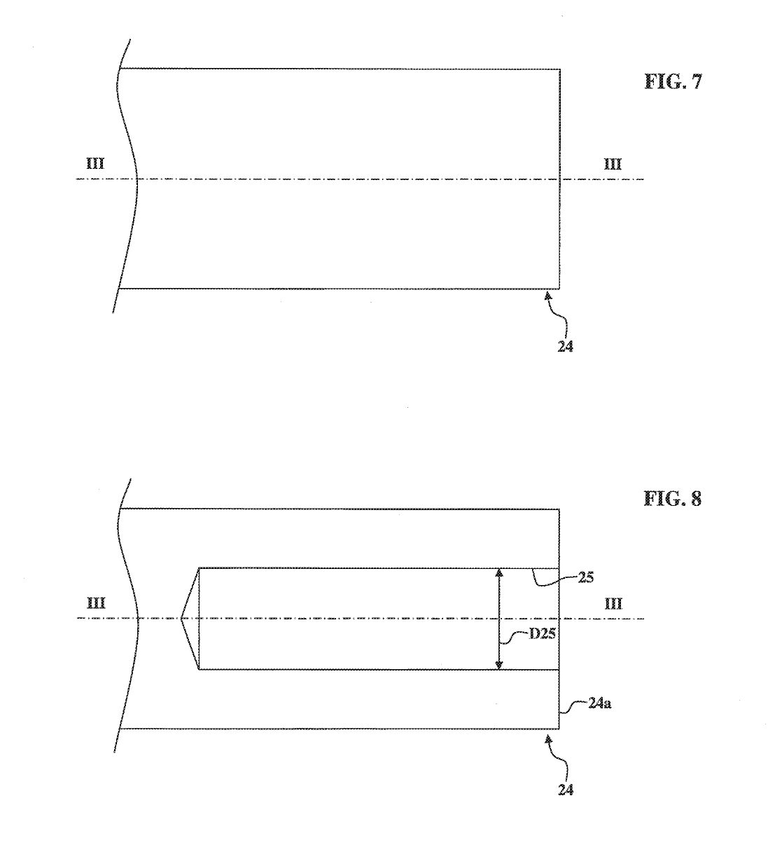

FIGS. 7 to 13 illustrate a second method for production of a metal insert 1 in a single piece as illustrated in FIGS. 2 and 3.

This second production method comprises a step A) during which a metal rod 24 is provided, which extends according to a longitudinal axis (FIG. 7).

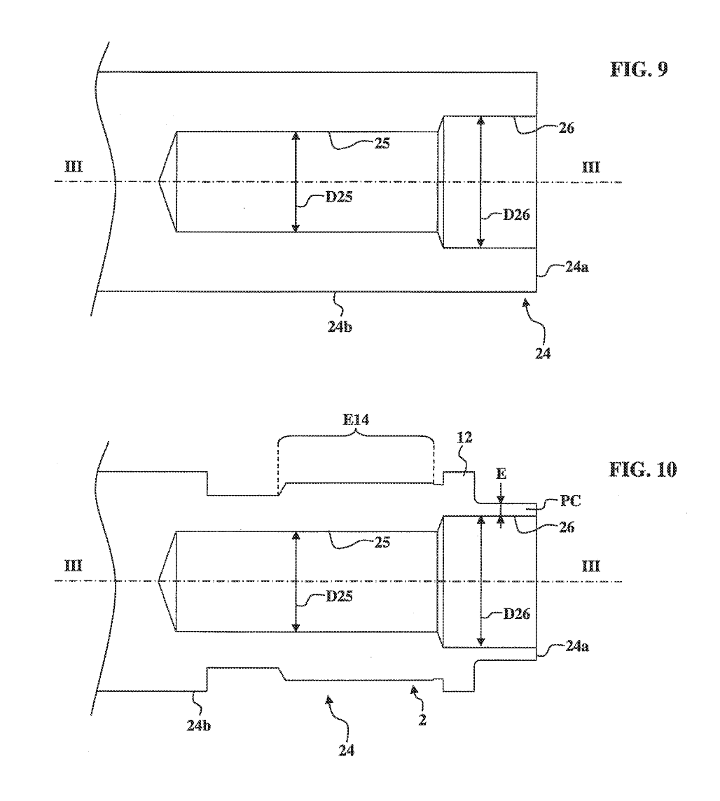

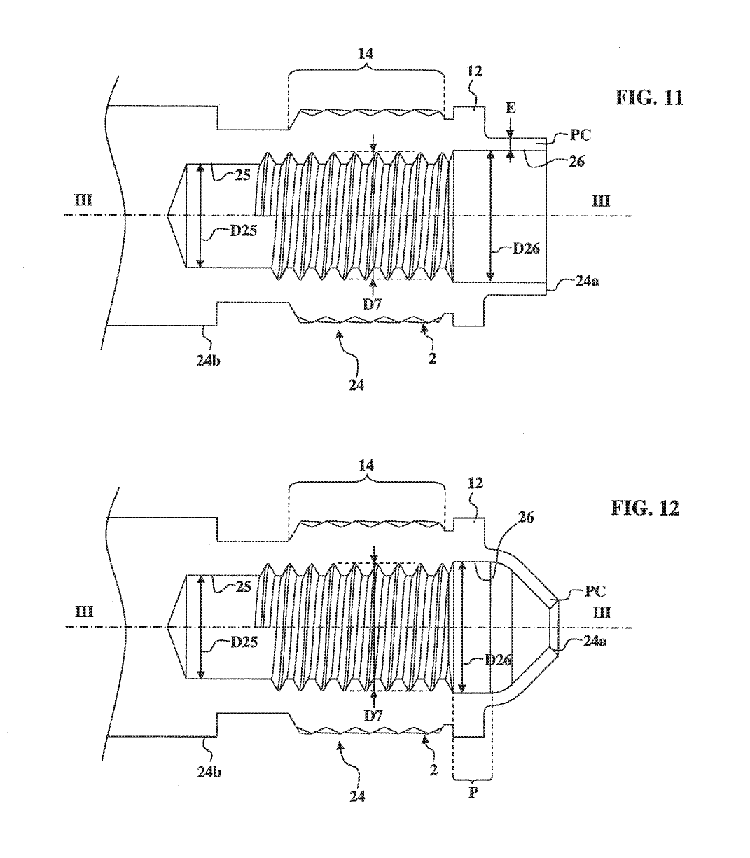

Then, in a step B), a first blind longitudinal hole 25 is pierced comprising a first diameter D25 at a free end 24a of the metal rod 24 (FIG. 8). Then, as illustrated in FIG. 9, at the free end 24a of the metal rod 24, a second longitudinal hole 26 is pierced, comprising a second diameter D26. The second diameter D26 is larger than the diameter D7 at the end of the tapping thread which is produced during a subsequent step illustrated in FIG. 11.

The lateral surface 24b of the metal rod 24 is then machined in order to produce the outer form of the body 2, by producing the flange 12 and a blank E14 of the section 14 with a non-circular transverse cross section (FIG. 10).

Then, the section 14 with a non-circular transverse cross section is formed by knurling the blank E14 as illustrated in FIG. 11.

During a step C), the first longitudinal hole 25 is tapped along at least part of its length, by introducing a tap into the first longitudinal hole 25 from the free end 24a of the metal rod 24 (FIG. 11).

Then, during a step D) illustrated in FIG. 12, at least part of the material which, constitutes the free end 24a of the metal rod 24 is worked by deformation, by turning this material down radially in the direction of the longitudinal axis until the first longitudinal hole 25 is closed substantially, or even completely.

The step D) of working by deformation can he carried out by longitudinal axial pressing of the free end 24a of the metal rod 24 into an anvil as illustrated in FIGS. 4 and 5. As an alternative, the working by deformation can be carried out by flow turning as illustrated in FIG. 6.

During this step D), there is no deformation of the material which constitutes the free end 24a of the metal rod 24 along a portion. P of the second longitudinal hole 26, said portion P being adjacent to the tapping carried out during the step C). The portion P makes it possible to constitute the section 11 which is smooth in its interior of the insert 1 illustrated in FIG. 2 or 3.

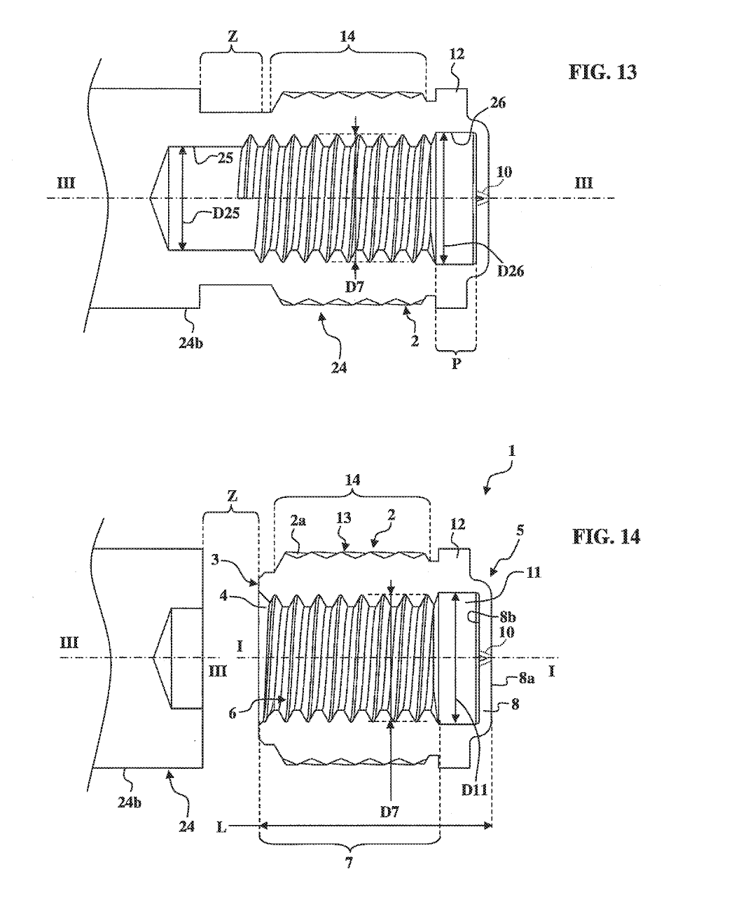

At the end of the step D) of working of material, the configuration illustrated in FIG. 13 is obtained, with complete closure of the first longitudinal hole 25, or only partial closure (illustrated in broken lines).

A step E) is then carried out of radial truncation of the metal rod 24 corresponding to an area Z which is at least partly tapped of the first longitudinal hole 25.

The configuration illustrated in FIG. 14 is then provided, in which a metal insert 1 in a single piece as illustrated in FIG. 2 or 3 is obtained.

If it has a sufficient length, the remainder of the metal rod 24 can be machined once more as illustrated in FIGS. 8 to 13, in order to form another metal insert 1 in a single piece as illustrated in FIG. 2 or 3.

It should be noted that the provision of the second longitudinal hole 26 is optional, and that, during the step D), it is possible to work by deformation at least part of the material which constitutes the free end of the metal rod 24 which has been tapped in its interior.

In this case, the end wall 8 will have an inner face 8b which is marked by the tapping carried out during the step C). And the end wall 8 can be worked as close as possible to the section 7 which is threaded in its interior of the insert 1. In this case, the provision of the second longitudinal hole 26 is rather advantageous, since it makes it possible simultaneously to obtain a section 11 which is smooth in its interior for clearance for a screw, whilst creating a cylindrical wall PC with a reduced thickness E (FIG. 11) at the free end 24a of the metal rod 24, in order to facilitate the working of material carried out during the step D).

It will also be noted that the second longitudinal hole 26 can be produced before the first longitudinal hole 25. It is only preferable to produce the second longitudinal hole 26 before the step C) in order to avoid having to carry out unnecessarily long tapping.

The present invention is not limited to the embodiments which have been explicitly described, but includes the different variants and generalizations of it which are contained within the context of the following claims.

1. A metal insert (1) in a single piece comprising:
a body (2) which extends according to a longitudinal axis (I-I) between a first end (3) which is open with an inlet orifice (4) and a second end (5),
between the first (3) and second (5) ends, a longitudinal passage (6) comprising a section (7) which is threaded in its interior,
an end wall (8) which closes the second end (5),
wherein the end wall (8) is made of metal which is worked radially in the direction of the longitudinal axis (I-I).

2. The metal insert (1) in a single piece as claimed in claim 1, wherein the section (7) which is threaded in its interior extends from the inlet orifice (4), and in the direction of the second end (5).

3. The metal insert (1) in a single piece as claimed in claim 1, wherein, between the section (7) which is threaded in its interior and the end wall (8), the longitudinal passage (6) comprises a section (11) which is smooth in its interior, with an inner diameter (D11) which is larger than the diameter (D7) at the end of the thread of the section (7) which is threaded in its interior.

4. The metal insert (1) in a single piece as claimed in claim 1, wherein it comprises a flange (12) on the outer surface (2a) of the body (2).

5. The metal insert (1) in a single piece as claimed in claim 1, wherein it comprises means (13) for blocking its rotation around the longitudinal axis (I-I) after overmolding.

6. The metal insert (1) in a single piece as claimed in claim 1, wherein it comprises a section (14) which has a non-circular transverse cross section on the outer surface (2a) of the body (2).

7. A method for production of metal insert (1) in a single piece, wherein it comprises the following steps:
1) providing a metal insert (100) in a single piece comprising:
a body (200) which extends according to a longitudinal axis (II-II) between a first end (300) which is open with an inlet orifice (400) and a second end (500),
between the first (300) and second (500) ends, a longitudinal passage (600) comprising a section (700) which is threaded in its interior,
a hollow open end section (900), comprising a cylindrical wall (800), said end section (900) extending the section (700) which is threaded in its interior away from the first open end (300),
2) working at least part of the cylindrical wall (800) of the end section (900) by deformation, by turning it down radially in the direction of the longitudinal axis (II-II) until the second end (500) of the body (200) is closed.

8. The production method as claimed in claim 7, wherein the end section (900) is smooth in its interior, and comprises an inner diameter (D900) which is larger than the diameter (D700) at the end of the thread of the section (700) which is threaded in its interior.

9. The production method as claimed in claim 7, wherein the step 2) is carried out by flow turning.

10. The production method as claimed in claim 7, wherein the step 2) is carried out by longitudinal axial pressing of the end section (900) of the metal insert (1) in a single piece against an anvil (15, 16).

11. A method for production of a metal insert (1) in a single piece, wherein it comprises the following steps:
A) providing a metal rod (24) which extends according to a longitudinal axis (III-III),
B) at a free end (24a) of the metal rod (24), piercing a first blind longitudinal hole (25) comprising a first diameter (D25),
C) tapping the first longitudinal hole (25) along at least part of its length by introducing a tap into the first longitudinal hole (25) from the free end (24a) of the metal rod (24),
D) working by deformation at least part of the material which constitutes the free end (24a) of the metal rod (24) by turning it down radially in the direction of the longitudinal axis (III-III) until the first longitudinal hole (25) is closed,
E) truncating the metal rod (24) radially corresponding to an area (Z) which is at least partly tapped of the first longitudinal hole (2).

12. The production method as claimed in claim 11, wherein:
before step the free end (24a) of the metal rod (24) is pierced by a second longitudinal hole (26) comprising a second diameter (D26),
the second diameter (D26) is larger than the diameter (D7) at the end of the thread of the tapping which is carried out during the step C),
during the step D), there is no deformation of the material which constitutes the free end of the metal rod (24) along a portion (P) of the second longitudinal hole (26), said portion being adjacent to the tapping carried out during the step C).

13. The production method as claimed in claim 11, wherein, before the step D), a lateral surface (24b) of the metal rod (24) is machined in order to produce a section (14) with a non-circular transverse cross section and/or a flange (12).

14. The production method as claimed in claim 11, wherein the step D) is carried out by flow turning.

15. The production method as claimed in claim 11, wherein the step D) is carried out by longitudinal axial pressing of the free end (24a) of the metal rod (24) against an anvil (15, 16).
